(19) United States
(12) Patent Application Publication
(10) Pub. No.: US 2018/0069975 A1
(43) Pub. Date: Mar. 8, 2018

(54) INFORMATION DISPLAY SYSTEM AND IMAGE FORMING APPARATUS

(71) Applicant: FUJI XEROX CO., LTD., Tokyo (JP)

(72) Inventors: Hiroshi HONDA, Kanagawa (JP); Chigusa NAKATA, Kanagawa (JP); Eiji NISHI, Kanagawa (JP); Yoshihiro SEKINE, Kanagawa (JP); Kenji KUROISHI, Kanagawa (JP); Hiroshi MIKURIYA, Kanagawa (JP); Takeshi FURUYA, Kanagawa (JP); Ryuichi ISHIZUKA, Kanagawa (JP)

(73) Assignee: FUJI XEROX CO., LTD., Tokyo (JP)

(21) Appl. No.: 15/467,027

(22) Filed: Mar. 23, 2017

(30) Foreign Application Priority Data
Sep. 2, 2016 (JP) 2016-171630

(51) Int. Cl. H04N 1/00

(52) U.S. Cl. CPC H04N 1/00503; H04N 1/00251; H04N 2201/0094; H04N 1/00039; H04N 1/00228

(57) ABSTRACT

Provided is an information display system including
plural situation grasping devices that are provided in an office room, each of which grasps surrounding situations, and
an image forming apparatus that forms an image on a recording medium, the image forming apparatus being provided in the office room and including a display which displays location related information of the situation grasping devices in the office room.

### CROSS-REFERENCE TO RELATED APPLICATIONS

This application is based on and claims priority under 35 USC 119 from Japanese Patent Application No. 2016-171630 filed Sep. 2, 2016.

### BACKGROUND

### Technical Field

The present invention relates to an information display system and an image forming apparatus.

### SUMMARY

According to an aspect of the invention, there is provided an information display system including:

plural situation grasping devices that are provided in an office room, each of which grasps surrounding situations; and

an image forming apparatus that forms an image on a recording medium, the image forming apparatus being provided in the office room and including a display which displays location related information of the situation grasping devices in the office room.

### BRIEF DESCRIPTION OF THE DRAWINGS

Exemplary embodiments of the present invention will be described in detail based on the following figures, wherein:

FIG. 1 is a view illustrating the overall configuration of a device management system according to an exemplary embodiment;

FIG. 2 is a view illustrating the configuration of an image forming apparatus;

FIG. 3 is a block diagram illustrating the functional configuration of a controller;

FIG. 4 is a view illustrating one example of a management table stored in a memory of the image forming apparatus;

FIG. 5 is a flowchart illustrating a flow of process when information on a newly provided sensor is registered in the management table of the image forming apparatus;

FIG. 6 is a flowchart illustrating a flow of process executed by a state grasping unit of the image forming apparatus when checking the life-and-death state of each sensor;

FIG. 7 is a view illustrating another display example in a display of the image forming apparatus;

FIG. 8 is a view illustrating another display example in the display;

FIG. 9 is a flowchart illustrating a flow of process executed when a displaying process is performed;

FIG. 10 is a view illustrating another display example in the display; and

FIG. 11 is a view illustrating another display example in the display.

### DETAILED DESCRIPTION

Hereinafter, an exemplary embodiment of the present invention will be described in detail with reference to the accompanying drawings.

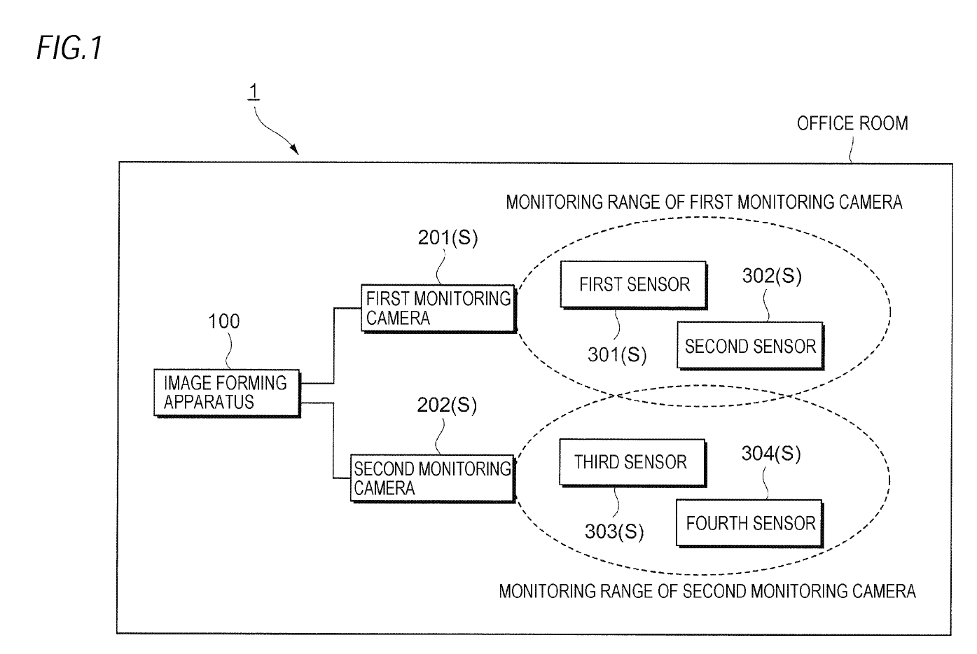

FIG. 1 is a view illustrating the overall configuration of a device management system 1 according to an exemplary embodiment.

The device management system 1 according to the present exemplary embodiment includes an image forming apparatus 100 that forms an image on a sheet which is one example of a recording medium.

In addition to the function of forming an image on a sheet, the image forming apparatus 100 further has a scanning function of reading an image on an original, and a FAX function of performing FAX transmission.

The device management system 1 further includes a first monitoring camera 201 and a second monitoring camera 202 functioning as situation grasping devices, and first to fourth sensors 301 to 304 also functioning as the situation grasping devices.

The first monitoring camera 201, the second monitoring camera 202, and the first to fourth sensors 301 to 304 grasp their respective surrounding situations.

Here, the image forming apparatus 100, the first monitoring camera 201, the second monitoring camera 202, and the first to fourth sensors 301 to 304 are provided in the same office room.

In addition, the image forming apparatus 100, the first monitoring camera 201, the second monitoring camera 202, and the first to fourth sensors 301 to 304 are connected to the same network. In other words, the first monitoring camera 201, the second monitoring camera 202, and the first to fourth sensors 301 to 304 are connected to the image forming apparatus 100.

In this exemplary embodiment, the image forming apparatus 100 receives information on situations grasped by each of the first monitoring camera 201, the second monitoring camera 202 and the first to fourth sensors 301 to 304.

The first monitoring camera 201, the second monitoring camera 202, the first to fourth sensors 301 to 304 may be connected to the image forming apparatus 100 via a wired line or over a wireless line using Wi-Fi (registered trademark), Bluetooth (registered trademark) or the like.

In the present specification, hereinafter, the first monitoring camera 201, the second monitoring camera 202 and the first to fourth sensors 301 to 304 will be simply referred to as sensors S unless not distinguished from one another.

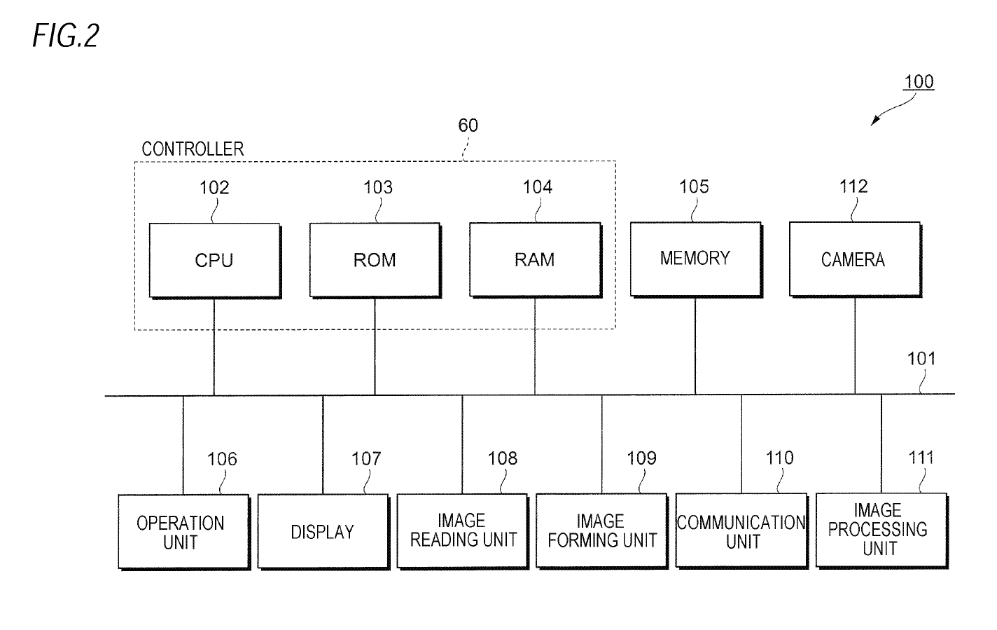

FIG. 2 is a view illustrating the configuration of the image forming apparatus 100.

Functional units configuring the image forming apparatus 100 according to the present exemplary embodiment are connected to a bus 101 and exchange data via the bus 101.

As illustrated in FIG. 2, the image forming apparatus 100 according to the present exemplary embodiment includes an operation unit 106. The operation unit 106 receives a user's operation. The operation unit 106 includes, e.g., a hardware key. Alternatively, the operation unit 106 may include, e.g., a touch panel that outputs a control signal corresponding to a pressed position.

A display 107, as an example of a display unit, includes, e.g., a liquid crystal display as a display device and displays information on the image forming apparatus 100 (information on image formation) under control of a controller 60. In addition, the display 107 displays a menu screen which is referred to by a user who operates the image forming apparatus 100. Further, the display 107 displays information on the sensors S.

An image reading unit 108 includes a so-called scanner device, reads an image on a set original and generates a read image (image data).

An image forming unit 109, as an example of an image forming unit, uses, e.g., an electrophotographic system to form a toner image according to image data on a sheet as one example of a recording medium.

Alternatively, the image forming unit 109 may use another method such as an inkjet head system to form an image.

The image forming apparatus 100 further includes a communication unit 110.

The communication unit 110 functions as a communication interface for communicating with other apparatuses such as the sensors S or other image forming apparatuses 100. More specifically, the communication unit 110 receives information on situations grasped by each of the sensors S (hereinafter referred to as “situation information”) from each sensor S.

The image forming apparatus 100 further includes an image processing unit 111 and a memory 105.

The image processing unit 111 performs an image processing such as color correction or tone correction on an image represented by the image data.

The memory 105 includes a storage device such as a hard disk device and stores various information.

Specifically, the memory 105 stores information on plural provided sensors S. More specifically, in the present exemplary embodiment, information on the sensors S is acquired by a sensor information acquiring unit 61, which will be described later, and the memory 105 stores the information on the sensors S acquired by the sensor information acquiring unit 61. Further, a management table (which will be described later) used for management of the sensors S is stored in the memory 105 which then uses the management table to manage the information on the sensors S.

The image forming apparatus 100 further includes a camera 112 as one example of a capturing unit.

The camera 112 includes, e.g., a charge coupled device (CCD). In the present exemplary embodiment, the situations in the office room are captured by the camera 112. More specifically, the sensors S or the like provided in the office room are captured.

The image forming apparatus 100 further includes a controller 60 that is used to control each part of the image forming apparatus 100.

The controller 60 includes a central processing unit (CPU) 102, a read only memory (ROM) 103 and a random access memory (RAM) 104.

The ROM 103 stores a program to be executed by the CPU 102. The CPU 102 reads the program stored in the ROM 103 and executes the program with the RAM 104 as a work area.

When the program is executed by the CPU 102, each unit of the image forming apparatus 100 is controlled by the CPU 102 to allow the image forming apparatus 100, for example, to form an image on a sheet or read an original to generate a read image of the original.

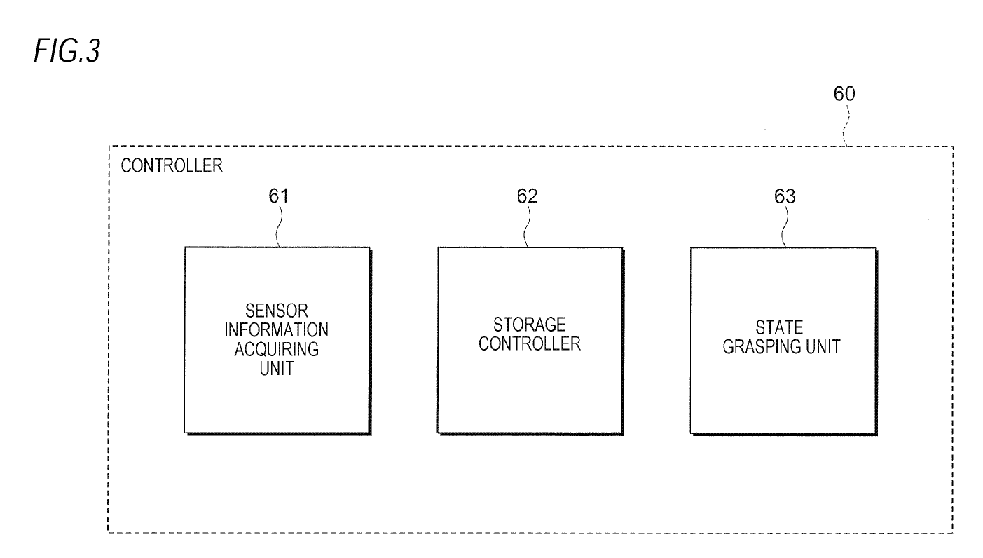

In the present exemplary embodiment, as the program is executed by the CPU 102, as illustrated in FIG. 3 (a block diagram illustrating the functional configuration of the controller 60), the controller 60 functions as the sensor information acquiring unit 61, a storage controller 62 and a state grasping unit 63.

The sensor information acquiring unit 61 acquires information on each of the plural provided sensors S. More specifically, the sensor information acquiring unit 61 acquires information on each of the sensors S via the communication unit 110 (see FIG. 2). Further, the sensor information acquiring unit 61 analyzes a result of capturing obtained by the camera 112 (see FIG. 2) to acquire the information on each sensor S.

The storage controller 62 causes the memory 105 to store the information on the sensors S acquired by the sensor information acquiring unit 61.

The state grasping unit 63 grasps the state of each of the plural provided sensors S.

The sensor information acquiring unit 61, the storage controller 62 and the state grasping unit 63 are implemented by cooperation of software and hardware resources.

Specifically, in the present exemplary embodiment, an operating system and programs executed in cooperation with the operating system are stored in the ROM 103 (see FIG. 2) or the memory 105. In the present exemplary embodiment, the CPU 102 reads these programs from the ROM 103 or the like into the RAM 104, which is a main storage device, and executes these programs to implement the respective functional units of the sensor information acquiring unit 61, the storage controller 62 and the state grasping unit 63.

Here, the programs executed by the CPU 102 may be provided to the image forming apparatus 100 in a form stored in a computer-readabie recording medium such as a magnetic recording medium (such as a magnetic tape, a magnetic disk), an optical recording medium (such as an optical disc), a magneto-optical recording medium, a semiconductor memory or the like. Further, the programs executed by the CPU 102 may be downloaded to the image forming apparatus 100 by a communication unit such as the Internet.

In the present exemplary embodiment, when a new sensor S is connected to the device management system 1 illustrated in FIG. 1, the image forming apparatus 100 detects the connection of a new sensor S to a communication line configuring the device management system 1 by UPnP (Universal Plug and Play) or the like.

In this case, the storage controller 62 of the image forming apparatus 100 registers the name of the new sensor S, its position on a network, and the like in a management table (the management table stored in the memory 105).

Furthermore, in the present exemplary embodiment, when the new sensor S is provided within a monitoring range of the first monitoring camera 201 or the second monitoring camera 202 which has been already provided, the name of the sensor S and its physical position are acquired by the first monitoring camera 201 or the second monitoring camera 202.

Then, the name and the position of the sensor S are output to the image forming apparatus 100, and the storage controller 62 of the image forming apparatus 100 registers the name and the position in the management table stored in the memory 105.

In other words, in the present exemplary embodiment, while the plural sensors S such as the first monitoring camera 201, the second monitoring camera 202 and the first to fourth sensors 301 to 304 are provided, there is a case where some of the plural provided sensors S acquire information on other sensors S newly provided. In the present exemplary embodiment, the information on the other sensors S acquired by the some sensors S is transmitted to the image forming apparatus 100 and registered in the management table of the image forming apparatus 100.

More specifically, in the present exemplary embodiment, when the new sensor S is provided within the monitoring range of the first monitoring camera 201 or the second monitoring camera 202 that has been already provided, a result of capturing obtained by the first monitoring camera 201 or the second monitoring camera 202 is analyzed by the sensor information acquiring unit 61 (see FIG. 3) of the image forming apparatus 100 to acquire the name and type of the newly provided sensor S.

Specifically, for example, a result of capturing on a two-dimensional barcode attached to the newlyy provided sensor S is analyzed to acquire the name and type of the sensor S. The name and type are registered in the management table of the image forming apparatus 100.

Furthermore, in the present exemplary embodiment, the sensor information acquiring unit 61 of the image forming apparatus 100 analyzes the capturing result obtained by the first monitoring camera 201 or the second monitoring camera 202 to grasp the relative position of the new sensor S to the first monitoring camera 201 or the second monitoring camera 202.

Then, the sensor information acquiring unit 61 grasps the physical (absolute) position of the new sensor S based on the grasped relative position.

Specifically, in the present exemplary embodiment, the physical position of the first monitoring camera 201 or the second monitoring camera 202 has been already registered in the management table and the sensor information acquiring unit 61 of the image forming apparatus 100 grasps the physical position of the new sensor S (position of the new sensor S in the office room) based on the physical position of the first monitoring camera 201 or the second monitoring camera 202 already registered in the management table and the relative position. Then, the storage controller 62 of the image forming apparatus 100 registers the physical position in the management table.

In the above description, the name and type of the newly provided sensor S are grasped based on the analysis result of the two-dimensional barcode. Alternatively, for example, the shape of the sensor S may be analyzed to grasp the name and type of the sensor S.

More specifically, for example, the shapes and names of various sensors S may be previously registered in the image forming apparatus 100 or an external server (not illustrated) connected with the image forming apparatus 100, and a pattern matching process may be performed between the shape of the sensor S (newly provided sensor S) captured by the first monitoring camera 201 or the second monitoring camera 202 and the registered shapes of the sensors S to grasp the name and type of the newly provided sensor S.

The physical position of the newly provided sensor S may be grasped based on the intensity and direction of a radio wave transmitted from the newly provided sensor S, which are grasped by the image forming apparatus 100, the first monitoring camera 201 or the second monitoring camera 202.

In addition, the physical position of each sensor S may be registered in the image forming apparatus 100 by a provider of the sensors, who manually inputs the physical position (information indicating a position such as coordinate information) through the operation unit 106 or the like.

In the present exemplary embodiment, the state grasping unit 63 of the image forming apparatus 100 grasps the life-and-death state of a sensor S at each predetermined timing. In other words, it is determined whether the sensor S is working normally.

More specifically, the state grasping unit 63 performs, e.g., ping or the like periodically on a sensor S registered in the management table or determines whether or not a push notification has come from the sensor S at each predetermined timing, to thereby determine whether or not the sensor S is working normally. Then, the state grasping unit 63 registers the state of each sensor S in the management table.

The state of the sensor S may be grasped by capturing each sensor S with the first monitoring camera 201, the second monitoring camera 202, the camera 112 included in the image forming apparatus 100, or the like. More specifically, the state of each sensor S may be grasped by analyzing a capturing result obtained by the first monitoring camera 201, the second monitoring camera 202, the camera 112 of the image forming apparatus 100, or the like.

More specifically, the light emission state of a light source provided in each sensor S may be grasped by the first monitoring camera 201, the second monitoring camera 202, the camera 112 of the image forming apparatus 100, or the like, and the state of the sensor S may be grasped based on this light emission state.

For example, a light source such as an LED is provided in each sensor S and is lit up/down at each predetermined timing. Then, the state grasping unit 63 (see FIG. 3) of the image forming apparatus 100 analyzes the capturing result obtained by the first monitoring camera 201, the second monitoring camera 202, the camera 112 of the image forming apparatus 100, etc., to determine whether the light source of the sensor S is lit up or lit down under a predetermined condition.

Then, when the light source is lit up or lit down under a predetermined condition, the state grasping unit 63 determines that the sensor S is working normally. Meanwhile, when the light source is not lit up or not lit down under the predetermined condition, the state grasping unit 63 determines that the sensor S is not working normally.

The light source may be provided for all the sensors S, or may be provided only in some of the sensors S, such as only in sensors S seen from the image forming apparatus 100.

In addition, information (stored in the management table) of the sensors S provided in the office room may be displayed on the display 107 of the image forming apparatus 100. Accordingly, the user may obtain the information on each sensor S by referring to the display 107.

When the information on the position of the sensor S is displayed on the display 107, a position of the sensor S on a network may be displayed without being limited to the physical position of the sensor S. Alternatively, a layout of arrangement of the sensors S may be displayed, as will be described later.

Further, in the present exemplary embodiment, when the user selects a sensor S from the plural sensors S displayed on the display 107, the image forming apparatus 100 instructs the selected sensor S to light up or down the light source.

As a result, the light source of the sensor S is lit up or down so that the user may more easily find the sensor S in the office room by referring to this lighting-up/down.

Specifically, some or all of the sensors S according to the present exemplary embodiment have their respective receiving units that receive an instruction from the image forming apparatus 100. Upon receiving a light source lighting-up/down instruction in the receiving units, the sensors S light up or down their respective light sources.

In this case, the user may more easily find the sensor S in the office room by referring to this lighting-up/down.

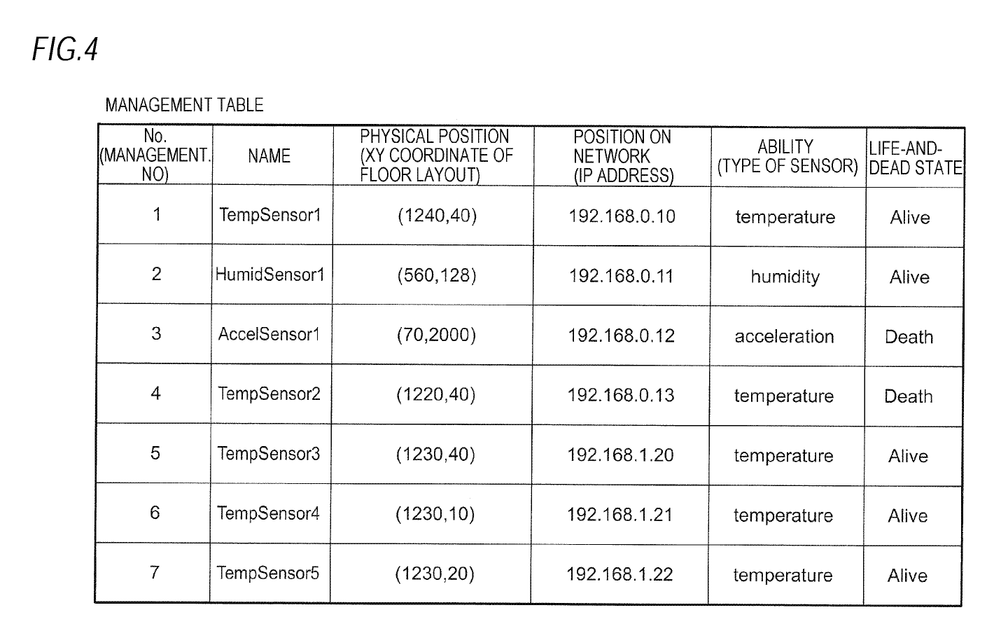

FIG. 4 is a view illustrating one example of the management table stored in the memory 105 of the image forming apparatus 100.

Information on each sensor S is registered in the management table according to the present exemplary embodiment More specifically, information on a management number, name, physical position (position coordinate of each sensor S in the office room), position (IP address) on a network, ability (the type of the sensor S) and the life-and-death state is registered in the management table in association.

In the present exemplary embodiment, when the user operates the operation unit 106 of the image forming apparatus 100, the management table is displayed on the display 107 to allow the user to check a list of the sensors S provided in the office room.

Furthermore, in the present exemplary embodiment, when any one of the sensors S is selected from this list by the user, as described above, the light source of the sensor S is lit up or down to allow the user to confirm the sensor S in the office room based on this lighting-up/down.

Further, in the present exemplary embodiment, as described above, the information on the management number, the name, the physical position, the position on a network, the ability and the life-and-death state may be associated with each other. As a result, when the user input some of the information on the sensor S such as the name of the sensor S to the operation unit 106, the user may check other information on the sensor S such as the physical position and the position on the network of the sensor S.

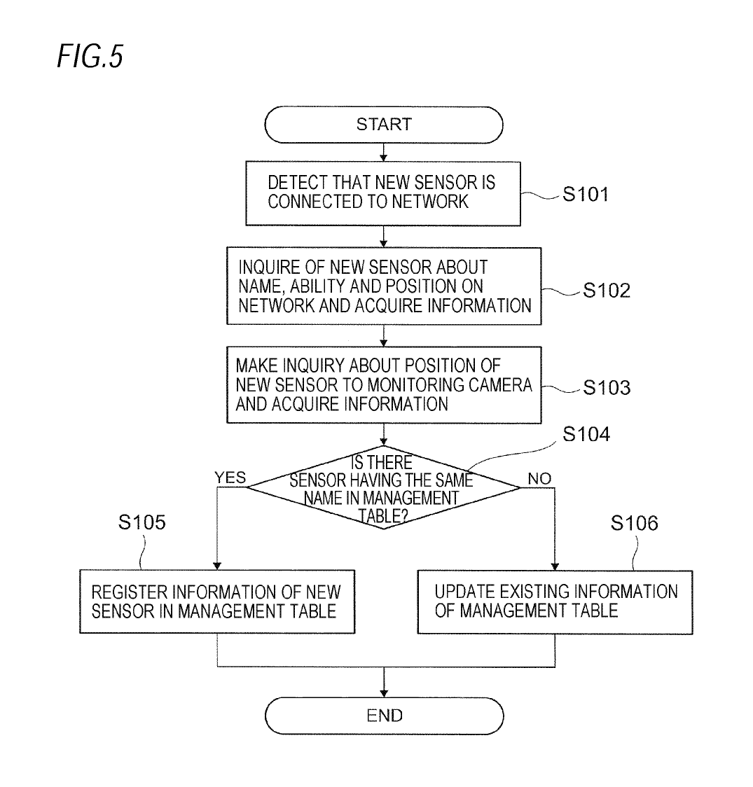

FIG. 5 is a flowchart illustrating a flow of a process when information on a newly provided sensor S is registered in the management table of the image forming apparatus 100.

In the present exemplary embodiment, first, the communication unit 110 of the image forming apparatus 100 detects that a newly provided sensor S (hereinafter referred to as a “new sensor S”) is connected to the network (step 101).

Next, the communication unit 110 of the image forming apparatus 100 inquires of the new sensor S about its name, ability, position on a network and the like and acquires these pieces of information (step 102).

Incidentally, in this process example, various information such as a name is already stored in the new sensor S, and the new sensor S is provided with an information transmitting/receiving unit.

In the processing of the step 102, an inquiry is made to the new sensor S from the communication unit 110 of the image forming apparatus 100 and, in response to this inquiry, the various information of the new sensor S is transmitted from the new sensor S to the image forming apparatus 100.

Further, in this process example, it is assumed that the new sensor S is provided within the monitoring range of the first monitoring camera 201 or the second monitoring camera 202 which has been already provided.

In this case, the sensor information acquiring unit 61 (see FIG. 3) of the image forming apparatus 100 makes an inquiry about the position of the new sensor S to the first monitoring camera 201 or the second monitoring camera 202, and acquires information (information indicating the relative position of the new sensor S to the first monitoring camera 201 or the second monitoring camera 202) returned from the first monitoring camera 201 or the second monitoring camera 202 (step 103).

Then, the sensor information acquiring unit 61 grasps the physical position of the new sensor S based on the information indicating the physical position of the first monitoring camera 201 or the second monitoring camera 202 (already stored in the management table) and the information indicating the relative position.

Next, the sensor information acquiring unit 61 of the image forming apparatus 100 checks whether or not there is a sensor S having the same name as the new sensor S in the management table (step 104). When the sensor S having the same name is not found in the management table, the storage controller 62 registers information on the new sensor S in the management table (step 105).

Meanwhile, when it is determined in step 104 that the sensor S having the same name as that of the new sensor S is found in the management table, the existing information on the management table is updated to new information as necessary (step 106).

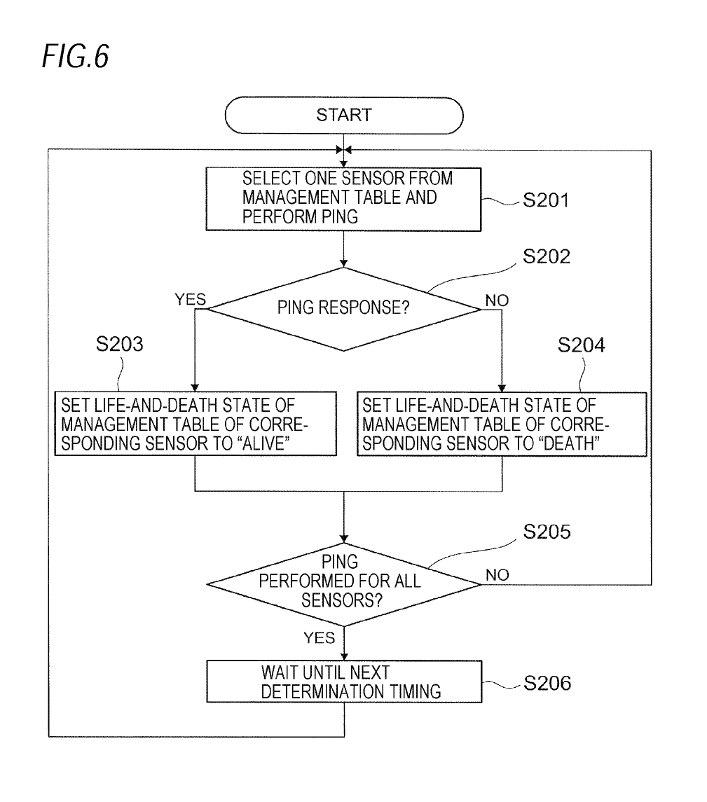

FIG. 6 is a flowchart illustrating a flow of a process executed when the state grasping unit 63 of the image forming apparatus 100 checks the life-and-death state of each sensor S.

In checking the life-and-death state of each sensor S first, the state grasping unit 63 (see FIG. 3) of the image forming apparatus 100 selects one sensor S from the management table and pings the selected sensor S (step 201). Then, the state grasping unit 63 determines whether or not there is a ping response (step 202).

When it is determined that there is a ping response, the state grasping unit 63 determines that the sensor S is working and sets the life-and-death state of the sensor S to “Alive” (step 203).

More specifically, in the present exemplary embodiment, as illustrated in FIG. 4, a field for registering the life-and-death state of each sensor S is provided in the management table, and the state grasping unit 63 registers information of “Alive” indicating that the sensor S is working in the field indicating the life-and-death state in association with the working sensor S.

Meanwhile, if it is determined in step 202 that there is no ping response, the state grasping unit 63 determines that the sensor S is not working, and sets the life-and-death state to “Death” (step 204).

More specifically, the state grasping unit 63 registers the information of “Death” in the field indicating the life-and-death state in the management table for the sensor S not working, as illustrated in FIG. 4.

Thereafter, the state grasping unit 63 determines whether or not ping has been performed for all the sensors S (step 205). When it is determined that ping has been performed for all the sensors S, the state grasping unit 63 waits until the next determination timing comes (step 206).

Meanwhile, if it is determined in step 205 that ping has not been performed for all the sensors S, the state grasping unit 63 performs the process again after the step 201.

Further, in the above description, the case where the image forming apparatus 100 is fixedly arranged has been described. However, the image forming apparatus 100 may be configured to automatically move. In other words, the image forming apparatus 100 may be configured to move autonomously. Further, the image forming apparatus 100 itself may grasp the name, the physical position and the like of each sensor S.

A mechanism for moving the image forming apparatus 100 is composed of, for example, a wheel provided at the bottom of the image forming apparatus 100 and a motor for rotating the wheel.

In the case of moving the image forming apparatus 100 itself, for example, the image forming apparatus 100 receives a radio wave from a sensor S provided in the office room, measures the intensity of the radio wave, and further grasps the physical position of the sensor S based on the direction of the radio wave and the intensity of the radio wave.

After specifying the physical position of the sensor S, the image forming apparatus 100 approaches the sensor S based on the position information of the sensor S. Then, the image forming apparatus 100 captures the sensor S using the camera 112 (see FIG. 2) to obtain a captured image of the sensor S.

Further, the image forming apparatus 100 analyzes the captured image to acquire the name and type of the sensor S. Specifically, the image forming apparatus 100 analyzes a two-dimensional barcode (a two-dimensional barcode attached to the sensor S) and the like included in the captured image to acquire the name and type of the sensor S.

Thereafter, the image forming apparatus 100 registers the acquired position and name of the sensor S in the management table. Although the case of acquiring the name and type of the sensor S from the two-dimensional barcode has been described here, the shape of the sensor S may be analyzed to acquire the name and type of the sensor S.

Further, the physical position of the sensor S may be grasped by using a terminal (such as a tablet terminal or a smartphone) owned by the provider who provides the sensor S.

More specifically, in this case, a number of transmitters (transmitting signals indicating provision positions) are provided in the office room in advance. The provider provides the terminal at a provision scheduled position of the sensor S, receives a radio wave transmitted from a transmitter at this terminal, and obtains the position information of the provision scheduled position of the sensor S.

Thereafter, the provider operates the operation unit 106 or the like of the image forming apparatus 100 to register the position information in the management table of the image forming apparatus 100.

In addition, as described above, a list of sensors S provided in the office room may be displayed on the display 107 or detailed information on some of the sensors S may be displayed on the display 107.

When the detailed information of the sensors S is displayed, for example, the user designates a sensor that the user wishes to display in detail, from the list of sensors S displayed on the display 107. Then, information on the designated sensor S is read from the management table and is displayed on the display 107. Accordingly, the detailed information such as position information, life-and-death state, ability and the like of this sensor S is displayed.

The information on the sensors S to be displayed on the display 107 may include not only static information but also dynamic information. For example, information sequentially output from the sensors S may be displayed on the display 107 in real time. In this case, when the information is displayed by graph, the outputs from the sensors S may be more easily understood.

Although the case where the information on the sensors S is displayed on the display 107 has been described above by way of example, the present invention is not limited to the display on the display 107 but may be applied to report outputs (printing on sheet), Web display, e-mail transmission, FAX transmission or the like.

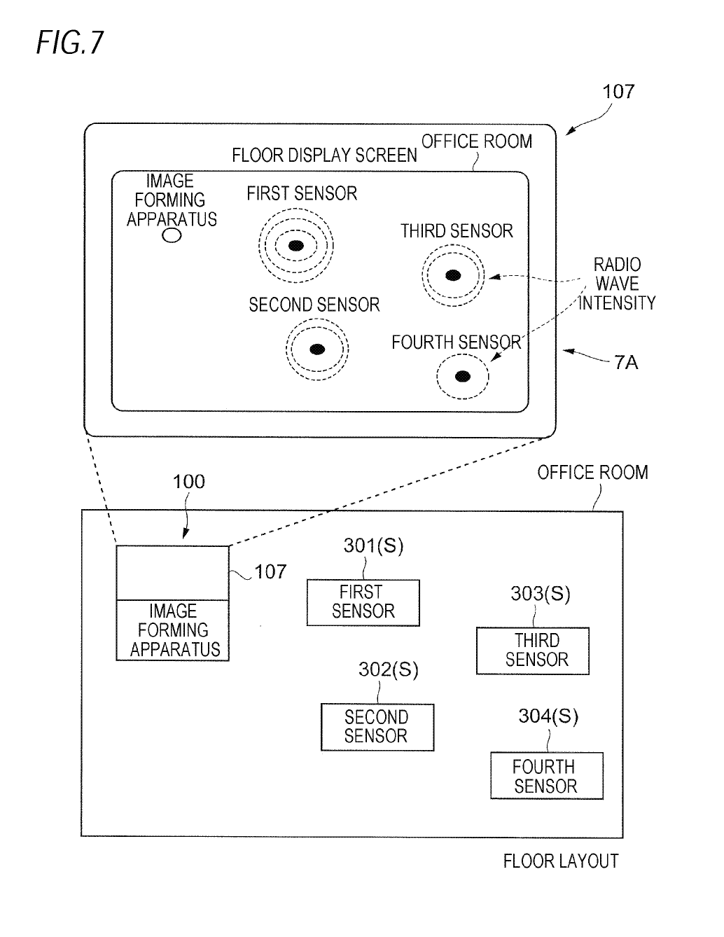

FIG. 7 is a view illustrating another display example in the display 107 of the image forming apparatus 100.

In the present exemplary embodiment, as described above, the physical position of each sensor S is acquired and information on this physical position is registered in the management table.

Then, in the present exemplary embodiment, when the user requests the operation unit 106 to display the positions (layout) of the sensors S, the information on the physical position of each sensor S is read out from the management table and, as indicated by reference numeral 7A in FIG. 7, the position of each sensor S is displayed on the display 107 of the image forming apparatus 100. In other words, position information (arrangement layout) of the sensors S in the office room is displayed.

Here, in this display, not only the sensors S (images showing the positions thereof) but also the image forming apparatus 100 (an image showing the position thereof) is displayed.

More specifically, in the present exemplary embodiment, position information of the image forming apparatus 100 is also registered in the management table (information on the image forming apparatus is not illustrated in FIG. 4) and, in addition to the positions of the sensors S, the position of the image forming apparatus 100 is also displayed on the display 107 of the image forming apparatus 100.

Registration of the position of the image forming apparatus 100 in the management table is performed, for example by the user who manually operates the operation unit 106, i.e., through a so-called manual input.

In addition, for example, by providing a GPS antenna in the image forming apparatus 100 and registering information obtained by the GPS antenna in the management table of the image forming apparatus 100, the position of the image forming apparatus 100 may be registered in the management table.

Further, an image representing the office room is also displayed in the display example illustrated in FIG. 7. When displaying the image representing the office room in this manner, the user may also grasp the positional relationship between the sensors S in the office room (i.e., may check any place of an office room where a sensor S is placed).

Here, the device management system 1 according to the present exemplary embodiment may be considered as an information display system for displaying the position information of the sensors S which are situation grasping devices.

Furthermore, in the present exemplary embodiment, as illustrated in FIG. 7, an image representing the intensity of a radio wave transmitted from a sensor S is also displayed.

Specifically, in the present exemplary embodimen for a sensor S which transmits a radio wave, not only an image representing the position of the sensor S but also an image representing the intensity of the radio wave transmitted from the sensor S is displayed. More specifically, for the sensor S that transmits the radio wave, the image representing the intensity of the radio wave transmitted from the sensor S is also displayed in association with the image representing the position of the sensor S.

Accordingly, the user may confirm the magnitude of the output of each sensor S by seeing the display 107.

The radio wave intensity of each sensor S may be measured by the image forming apparatus 100.

In addition, for example, each sensor S may have a function of measuring the radio wave intensity to measure the radio wave intensity by itself.

When the sensor S itself measures the radio wave intensity, a measurement result of the radio wave intensity is transmitted to the image forming apparatus 100 and is displayed on the display 107.

Although a top view (a view when viewing the office room from above), a so-called plan layout, is illustrated in the display example of FIG. 7, a side view (a view when viewing the office room from the side) may be displayed. In this case, a positional relationship between the sensors S in the vertical direction is displayed. In other words, the position information of the sensors S in the vertical direction is displayed.

Although the case where the arrangement layout of the sensors S is displayed on the display 107 has been described above, this is just illustrative. For example, an image representing the arrangement layout of the sensors S may be formed on a sheet and the sheet with the arrangement layout of the sensors S may be output.

In addition, the image representing the arrangement layout of the sensors S may be externally transmitted by FAX transmission, e-mail transmission or the like.

In the display illustrated in FIG. 7, not only the position information of each sensor S but also information on the office room (such as information on position coordinates of elements configuring the office room) is also required.

The information on the office room may be acquired, for example, by scanning a floor map, on which the office room is located, with the image forming apparatus 100 to take the floor map into the image forming apparatus 100 and by analyzing the floor map (a scanned image of the floor map) with the image forming apparatus 100.

Further, for example, electronic data obtained by computerizing the floor map of the office room may be transmitted from a personal computer (PC) or the like to the image forming apparatus 100 so that the information on the office room may be taken into the image forming apparatus 100.

Further, for example, the information on the office room may be acquired by running a self-propelled robot equipped with a camera in the office room.

In the present exemplary embodiment, in performing the display illustrated in FIG. 7, the image forming apparatus 100 generates an image in which a sensor S is superimposed on the floor map, and displays the generated image on the display 107.

In the present exemplary embodiment, information on the plural sensors S provided in the office room is stored in the image forming apparatus 100 and is consolidated in one place.

Accordingly, the user may operate the image forming apparatus 100 to confirm the information on all the sensors S provided in the office room.

Here, the management of the sensors S may be performed by individual providers who have provided the sensors S. However, in this case, the information may be diffused so that the sensors S may not be managed.

Furthermore, in the present exemplary embodiment, the information on the sensors S is stored in the image forming apparatus 100 rather than a PC or the like possessed by the user.

Once the image forming apparatus 100 is provided in the office room, it is not frequently moved. Therefore, when the information on the sensors S is stored in the image forming apparatus 100, the information on the sensors S will hardly be moved (diffused).

Furthermore, since the number of provided image forming apparatuses 100 is smaller than the PCs or the like, when the information of the sensors S is stored in the image forming apparatus 100, the information of the sensors S is hardly distributed and stored in plural apparatuses.

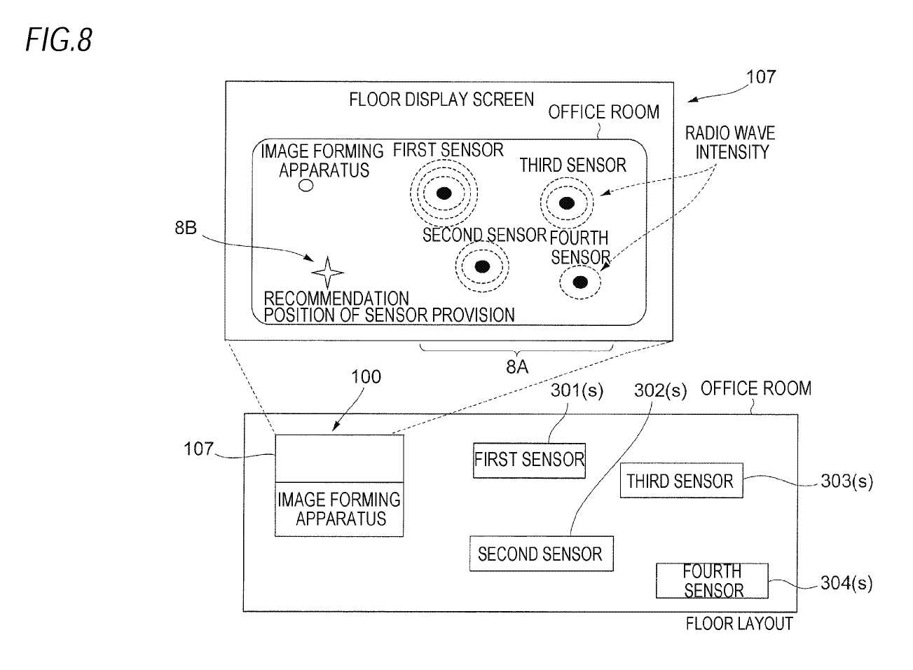

FIG. 8 is a view illustrating another display example in the display 107.

The case of displaying the information on the already provided sensors S has been illustrated and described in FIG. 7. However, as illustrated in FIG. 8, information indicating a provision position of a sensor S newly provided in the office room may be additionally displayed on the display 107.

More specifically, in the display example illustrated in FIG. 8, the provision position of the newly provided sensor S is estimated and the estimated provision position is displayed. In other words, a recommendation position at the time of providing the new sensor S is displayed.

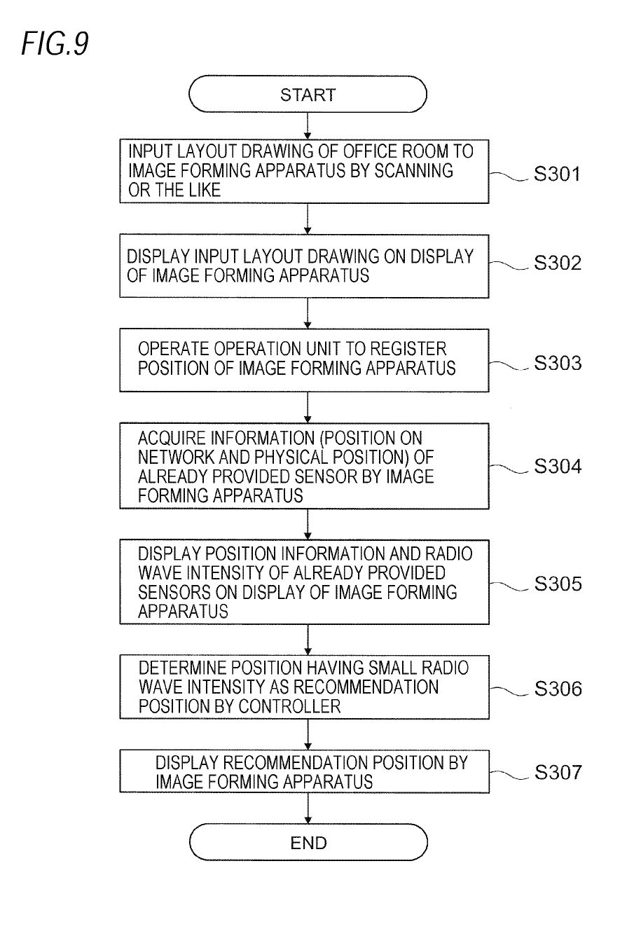

Here, in performing the display illustrated in FIG. 8, as illustrated in FIG. 9 (a flowchart illustrating a flow of process at the time of performing a displaying process), a layout drawing of the office room is first scanned and input to the image forming apparatus 100 (step 301).

Next, the display 107 of the image forming apparatus 100 displays the input layout drawing (step 302). Next, the user operates the operation unit 106 to register the position of the image forming apparatus 100 in the image forming apparatus 100 (step 303).

Next, the controller 60 (see FIG. 2) of the image forming apparatus 100 reads out and acquires information on an already registered sensor S (position information (position information on a network and physical position information)) from the management table (step 304).

Next, as denoted by reference numeral 8A in FIG. 8, the display 107 displays the position information of the sensors S (provided sensors S) and also displays the radio wave intensity of each sensor S (step 305).

Next, in the present exemplary embodiment, the controller 60 estimates a place where no sensor S is located and radio wave intensity is small in the office room, and determines a position at which the radio wave intensity is estimated to be small, as a recommendation position (step 306).

In the present exemplary embodiment, the controller 60 determines the recommendation position as a solution to the optimal placement problem. More specifically, the controller 60 calculates the total sum of distances from the respective sensors S already placed in the office room to a certain position, and determines a position at which the total sum is the largest, as the recommendation position. Next, the display 107 displays the recommendation position as denoted by reference numeral 8B in FIG. 8 (step 307).

In the case where the display illustrated in FIG. 7 is performed (when the recommendation position is not displayed), the process of the above-described steps 301 to 305 is executed.

In other words, regardless of whether the display illustrated in FIG. 7 or the display illustrated in FIG. 8 is performed, the process from step 301 to step 305 is commonly performed. When the recommendation position is displayed, the process of steps 306 and 307 is performed in addition to the process from step 301 to step 305.

Although the case of displaying the recommendation position for one sensor S has been described in the display example illustrated in FIG. 8, plural recommendation positions may be displayed.

Specifically, for example, the number of sensors S to be additionally provided may be received from the user, and the number of recommendation positions according to the received number of sensors S may be displayed.

The determination of the recommendation position may be made without considering the intensity of the radio wave.

Specifically, for example, a movement line of a person may be grasped by a monitoring camera provided in the office room, and a place where the person frequently passes may be determined as a recommendation position.

Further, the recommendation position may be determined depending on the type of a sensor S and the application of a user. Specifically, for example, for a sensor S for crime prevention, a recommendation position is determined based on a physical position such as a position close to a window (not illustrated) in the office room. Further, for example, for a sensor S for measuring the temperature of an office, a recommendation position is determined in consideration of the movement line of a person. Further, for example, for a sensor S (e.g., a temperature sensor) provided in a server room or the like, a recommendation position is determined based on a physical position without considering the movement line of a person.

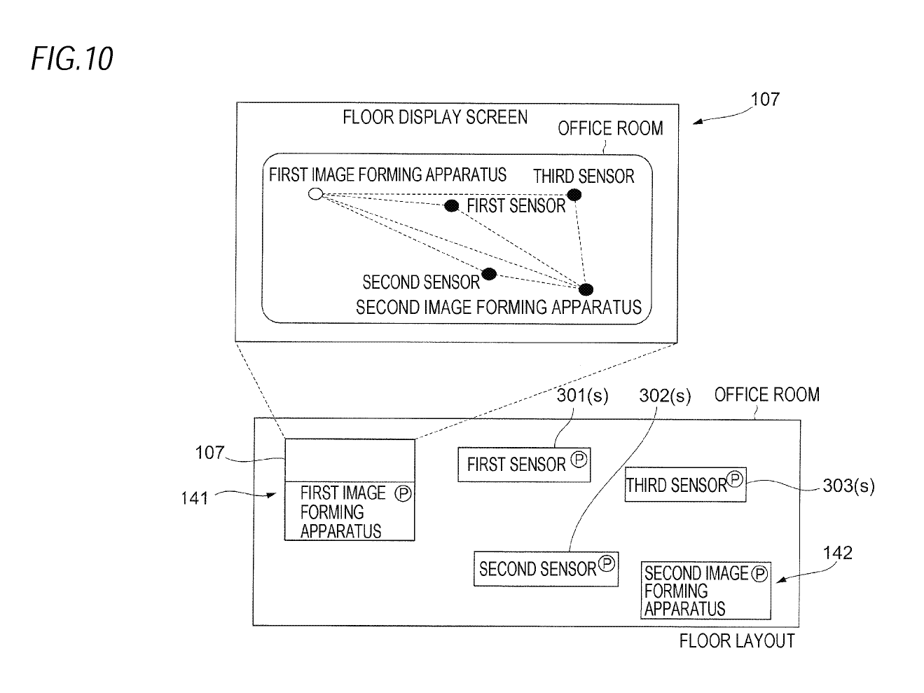

FIG. 10 is a view illustrating another display example in the display 107.

In the example illustrated in FIG. 10, two image forming apparatuses, namely a first image forming apparatus 141 and a second image forming apparatus 142, are provided in the office room, and the position information of the two image forming apparatuses and sensors S is displayed on a display 107 of the first image forming apparatus 141.

Further, in this example, each of the first image forming apparatus 141 and the second image forming apparatus 142 includes a radio wave transmitting unit (not illustrated) to transmit a radio wave.

In performing the display illustrated in FIG. 10, a distance between the first image forming apparatus 141 and the second image forming apparatus 142 and the positional relationship between the first image forming apparatus 141 and the second image forming apparatus 142 (a direction in a case of viewing the second image forming apparatus 142 from the first image forming apparatus 141 and a direction when viewing the first image forming apparatus 141 from the second image forming apparatus 142) are measured in advance, and a measurement result (the distance and the directions) (hereinafter referred to as “reference data”) is registered in both the first image forming apparatus 141 and the second image forming apparatus 142.

In the present exemplary embodiment, a barometer P is provided in each of the first image forming apparatus 141, the second image forming apparatus 142 and the first to third sensors 301 to 303.

In the present exemplary embodiment, the first image forming apparatus 141 captures radio waves emitted from the sensors S and the second image forming apparatus 142, and calculates a distance to each sensor S and a direction in which each sensor S is located, based on a result of the capture of the radio waves and the reference data (the distance between the first image forming apparatus 141 and the second image forming apparatus 142 and the directions thereof).

Further, the first image forming apparatus 141 grasps the position of each sensor S in the vertical direction based on a value of the barometer P of its own and a value of the barometer P output from each sensor S.

Next, the first image forming apparatus 141 grasps a three-dimensional arrangement layout of the sensor S based on the distance to each sensor S, the direction, and the position of each sensor S in the vertical direction.

In the exemplary embodiment illustrated in FIG. 10, the first image forming apparatus 141 and the second image forming apparatus 142 serve as reference points, and the position of each sensor S relative to these reference points is grasped.

In other words, in the exemplary embodiment illustrated in FIG. 10, the office room is not displayed and the position of each sensor S relative to the first image forming apparatus 141 and the second image forming apparatus 142 is grasped rather than the position of each sensor S relative to the office room. Then, the position of each sensor S relative to the first image forming apparatus 141 and the second image forming apparatus 142 and the mutual positional relationship of the plural provided sensors S are displayed on the display 107 of the first image forming apparatus 141.

Further, in the exemplary embodiment illustrated in FIG. 10, as described above, since the three-dimensional layout is grasped, it is possible to display a planar layout and also a lateral layout (a layout of the sensors S in the vertical direction), as illustrated in FIG. 10.

Furthermore, in the present exemplary embodiment, the display 107 may be operated to perform pinch-out/pinch-in and enlarge/reduce display. In addition, in this processing example, the display 107 may also be operated to rotate a display image.

Although not described in the above, for the display examples illustrated in FIGS. 7 and 8, similarly, the display 107 may be operated to enlarge/reduce the display and rotate the display image.

In the exemplary embodiment illustrated in FIG. 10, as described above, the office room is not displayed. However, even without displaying the office room, when the positional relationship between the sensors S and the first image forming apparatus 141 or the second image forming apparatus 142 is displayed, the user may grasp the position of the sensors S.

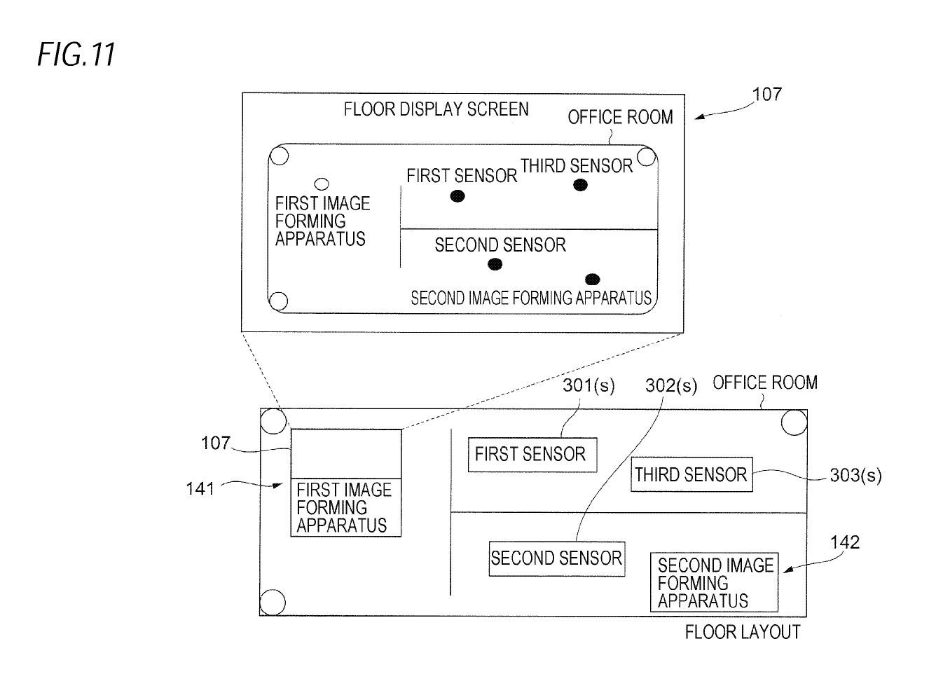

In the meantime, as illustrated in FIG. 11 (which is a view illustrating another display example in the display 107) when the office room is also displayed, the position of each sensor S relative to the office room is also displayed to make it easier for the user to find the sensor S.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information display system comprising:
a plurality of situation grasping devices that are provided in an office room, each of which grasps surrounding situations; and
an image forming apparatus that forms an image on a recording medium, the image forming apparatus being provided in the office room and including a display which displays location related information of the situation grasping devices in the office room.

2. The information display system according to claim 1, wherein
the display of the image forming apparatus displays an image indicating a position of each of the situation grasping devices and displays an image indicating an intensity of a radio wave emitted from a situation grasping device in association with the image indicating the position.

3. The information display system according to claim 1, wherein
the display of the image forming apparatus displays the location related information of the situation grasping devices when viewing the office room from above.

4. The information display system according to claim 2, wherein
the display of the image forming apparatus displays the location related information of the situation grasping devices when viewing the office room from above.

5. The information display system according to claim 1, wherein
the display of the image forming apparatus displays the location related information of the situation grasping devices and displays an image indicating the office room.

6. The information display system according to claim 2, wherein
the display of the image forming apparatus displays the location related information of the situation grasping devices and displays an image indicating the office room.

7. The information display system according to claim 3, wherein
the display of the image forming apparatus displays the location related information of the situation grasping devices and displays an image indicating the office room.

8. The information display system according to claim 4, wherein
the display of the image forming apparatus displays the location related information of the situation grasping devices and displays an image indicating the office room.

9. The information display system according to claim 1, wherein
the display of the image forming apparatus further displays an image indicating a position of the image forming apparatus.

10. The information display system according to claim 2, wherein
the display of the image forming apparatus further displays an image indicating a position of the image forming apparatus.

11. The information display system according to claim 3, wherein
the display of the image forming apparatus further displays an image indicating a position of the image forming apparatus.

12. The information display system according to claim 4, wherein
the display of the image forming apparatus further displays an image indicating a position of the image forming apparatus.

13. The information display system according to claim 5, wherein
the display of the image forming apparatus further displays an image indicating a position of the image forming apparatus.

14. The information display system according to claim 6, wherein
the display of the image forming apparatus further displays an image indicating a position of the image forming apparatus.

15. The information display system according to claim 7, wherein
the display of the image forming apparatus further displays an image indicating a position of the image forming apparatus.

16. The information display system according to claim 8, wherein
the display of the image forming apparatus further displays an image indicating a position of the image forming apparatus.

17. The information display system according to claim 1, wherein
the display of the image forming apparatus further displays information indicating a provision position of a situation grasping device newly provided in the office room.

18. The information display system according to claim 2, wherein
the display of the image forming apparatus further displays information indicating a provision position of a situation grasping device newly provided in the office room.

19. The information display system according to claim 3, wherein
the display of the image forming apparatus further displays information indicating a provision position of a situation grasping device newly provided in the office room.

20. An image forming apparatus comprising:
a display device that displays information on image formation to a user;
a display that displays, on the display device, location related information of a plurality of situation grasping devices provided in an office room, each of which grasps surrounding situations; and
an image forming unit that formals an image on a recording medium.
